(19) United States
(12) Patent Application Publication
(10) Pub. No.: US 2006/0222871 A1
(43) Pub. Date: Oct. 5, 2006

(54) Method for lowering deposition stress, improving ductility, and enhancing lateral growth in electrodeposited iron-containing alloys

(76) Inventors: Christian Rene Bonhote, San Jose, CA (US); John W. Lam, San Jose, CA (US); Lubomyr T. Romankiw, Briarcliff Manor, NY (US); Xiaoyan Shao, Yorktown Heights, NY (US)

Correspondence Address: ZILKA-KOTAB, PC, P.O. BOX 721120, SAN JOSE, CA, 95172-1120, US

(21) Appl. No.: 11/097,538

(22) Filed: Mar. 31, 2005

(51) Int. Cl. B32B 15/04; C25D 5/18

(52) U.S. Cl. 428/457; 205/105

(57) ABSTRACT

The present invention provides an electrodeposition/plating method for metal films and alloys in a bath which contain ferric ions and which usually deposit with high stress, but which when electrodeposited under pulse plating conditions in the presence of low valence vanadium or other ions capable of existing in multiple valence states produce low stress films and alloys and furthermore when plated through a mask creep laterally through walls and creep laterally along the surface of the mask to permit formation of overhangers, bridges, heat exchangers, and other complex three dimensional micro structures of low stress.

### FIELD OF THE INVENTION

The present invention relates to electrodeposition and more particularly, this invention relates to a system, bath, composition, and method, using an additive for improving electrodeposition results of FeCo alloys, and imparting new properties to deposited FeCo and other Fe-containing alloys.

### BACKGROUND OF THE INVENTION

Electrodeposition or electroplating is a common process for depositing a thin film of metal or alloy on a workpiece article such as various electronic components. In electroplating, the article is placed in a suitable electrolyte bath containing ions of a metal or alloy to be deposited. The article forms a cathode which is connected to the negative terminal of a power supply, and a suitable anode is connected to the positive terminal of the power supply. Electrical current flows between the anode and cathode through the electrolyte, and metal is deposited on the article with supplied electrons at the cathode by electrochemical reaction.

High moment, soft magnetic materials are used for a variety of applications. Examples of such applications include magnetic thin film heads, thin film inductors for RF and microwave circuits, and magnetic random access memory (MRAM) arrays.

In magnetic thin film heads, as the areal magnetic recording density increases, it is necessary to write onto progressively higher coercivity (H_{c}) magnetic storage medium. This in turn requires the write heads, or at least the pole tips to be made of the highest possible magnetic moment materials.

FIG. 1 shows the ternary diagram 100 of the magnetic intrinsic induction (Bₛ) of CoFeNi alloys [from R. M. Bozorth, “Ferromagnetism” (FIG. 5-80)]. It illustrates that CoFe alloys between 50%-70% Fe have the highest magnetic flux density (Bₛ≧2.4 T) among all ferromagnetic materials. The successful manufacturing of these alloys by electrodeposition is critical for achieving recording density of 100 Gb/in² and higher.

Electrodeposited FeCo and other Fe-containing alloys usually grow with high stress due to hydrogen evolution during plating, and codeposition of oxide and hydroxide between the grains. When hydrogen escapes from the film, high tensile stress develops due to the loss of volume occupied by hydrogen gas. Because of the presence of Fe hydroxide in the intergranular regions, even with relatively low tensile stress, films tend to crack and exfoliate. The maximum thickness of films, which has been achieved in FeCo films without cracking and exfoliating was 1.0 to 2.0 microns. FIG. 2 shows a Co₃₆Fe₆₄ film 200 of 3 micron-thick deposit cracked into pieces and peeling from the substrate due to high tensile stress and brittleness of the film when deposited in a standard sulfate/acetate bath.

By increasing the solution temperature, the deposition stress can be decreased due to the increased surface diffusion of FeCo atoms. However, increased temperature also results in increased grain size, which leads to undesirable higher coercivity of the film, which will require much higher current for overwriting. In addition, equipment to withstand the higher temperature is costly and is also much more costly to maintain. A relatively new approach to lower the deposition stress of FeCo alloys is addition of an organic additive, e.g. carboxylic acid to the plating bath, as described in US Patent Appl. Pub. No. 2003/0209295A1. Lowering the Fe³⁺ concentration in the bath using filtration through Fe powder has also been found to lower the deposition stress of FeCo alloys. However, each of these approaches has its limits.

What is therefore needed is a way to reliably form thicker electrodeposited materials.

What is also needed is a way to reduce the deposition stress of electrodeposited materials.

In this invention, we demonstrated that by using VO²⁺, V³⁺, or V²⁺ ions in the bath, we are able to get a preferential growth of the film in the lateral direction and achieve unusually high ductility. This in term permits to plate FeCo films as thick as 10 microns without cracking and exfoliating. This is an unexpected and surprising finding. We believe that it is due to the fact that low valence vanadium ions stop or slow down oxidation of Fe²⁺ to Fe³⁺ and entrapment of oxides and hydroxides, which usually codeposits with the metal and causes low ductility and easy fracture of film between grains. Since Fe³⁺ is present in variety of other alloy deposition solutions, such as NiFe, NiFeCo, FeZn, etc., we believe that this approach is equally applicable to plating of NiFe, NiFeCo, FeZn, and other Fe-containing alloys deposition. Because of the mechanism by which Fe³⁺ is occluded in these alloys, we believe our invention applies to all plating bath containing Fe²⁺ and Fe³⁺. Having explained the mechanism by which low valence vanadium ions changes the nature of film growth and the properties of the film from brittle to ductile. We postulate that this same mechanism will hold where other multiple valence ions used in the low valence states. This would include cations, such as Mg, Mn, Cr ions, anions, such as I, and other reducing agents, such as isoascorbic acid, etc., which would reduce Fe³⁺ to Fe²⁺ before it reaches the deposition surface.

The other unexpected and surprising finding is that, pulse plating from a solution containing low valence V ions significantly increased film ductility and lowered the deposition stress; while DC (direct current) plating from the same solution only increased the film ductility without significant effect on film stress. As a result, when pulse plating is used, as thick as 10 microns CoFe films can be plated, compared to a maximum CoFe film thickness of 4 microns from DC plating.

The other unexpected phenomenon is the fact the films when plated through resist masks, they first built up very uniformly in the cavity, and before reaching the top of the resist they begin to grow along the sidewalls and laterally on top of the photoresist. This suggests that it is possible, using plating through the mask, to bridge over the top of the resist and merge with the films growing out of adjacent cavity. When the films merge, it is possible to produce, after removal of the resist, channels, cavities, micro-hangers, micro-heat exchangers, and other very interesting three dimensional structures.

### SUMMARY OF THE INVENTION

The present invention provides an electrodeposition/plating method for metal films and alloys in a bath which contain ferric ions and which usually deposit with high stress, but which when electrodeposited under pulse plating conditions in the presence of low valence vanadium, manganese, or other ions capable of existing in multiple valence states produce lower stress films and alloys and which have a tendency to grow laterally on a flat surface. The lateral growth permits the creation of structures like micro-hangers, bridges, heat exchangers, and other complex three dimensional micro structures.

A method for electrodeposition according to one embodiment includes creating a bath containing metallic ions, ferrous and ferric ions, and an effective amount of an additive operative to reduce a tensile stress of a material formed in the bath as compared to a material formed in an otherwise identical bath not having the additive. An electrical current is applied through the bath for forming an electrodeposited structure of low tensile stress.

As mentioned above, the additive can be vanadium or manganese. The additive can also be ions capable of reducing the ferric ions to ferrous ions. Metals that can form part of the electrodeposited material include Co, Ni, Zn, and Cu to form such alloys as CoFe, NiFe, etc. These alloys may contain trace amounts of the additive.

Because of the low tensile stress and high ductility in the plane of the film, the electrodeposited structure can have a thickness of 10 microns or more, even when the electrodeposition is conducted at room temperature.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a ternary diagram of the intrinsic induction of FeCoNi alloys.

FIG. 2 is a microscopically enhanced view of a cracked 3 μm-thick CoFe film deposited by a standard electrodeposition process.

FIG. 3 is a microscopically enhanced view of a 10 μm-thick CoFe film deposited in a vanadium-containing solution.

FIG. 4A is a microscopically enhanced view of a CoFe deposition into a patterned trench using a vanadium-containing solution and pulse plating.

FIG. 4B is a cross sectional view of the CoFe deposition of FIG. 4A.

FIG. 5 is a chart showing a comparison of stress for films deposited under DC and pulse plating conditions as a function of Fe composition from a vanadium-free solution.

FIG. 6 is a chart showing a comparison of stress for films deposited under DC and pulse plating conditions as a function of iron composition from a vanadium-containing solution and a vanadium-free solution.

FIGS. 7A-B are cross-sectional diagrams showing the formation of heat exchanger structure using electroplating through and over photoresist from vanadium-containing CoFe solutions.

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

As mentioned above, the high tensile stress during electrodeposition of CoFe and other alloys, especially CoFe with a high percentage of Fe (e.g.,>50 wt% Fe), creates a problem for plating mechanically strong and reliable films with thickness greater than 4 microns. In searching for a solution to this problem, a process was developed for lowering the stress in as-plated metal films and, to the surprise of the inventors, greatly enhancing the lateral growth of metal alloys from a sulfate bath by using low or multi valence ionic materials such as vanadium compounds as additives and using pulse plating conditions.

Pulse plating of CoFe and other magnetic or nonmagnetic alloys from a vanadium-containing solution significantly lowers the tensile stress. The combination of pulse plating and vanadium addition not only increased the maximum thickness that can be deposited without cracking (10 micron as opposed to 4 micron), but also lowers the deposition stress of CoFe films. Similar results are obtained when forming other alloys, e.g., NiFe, in a bath containing low valence V, Mn, and/or other ions having multiple valence states which are capable of reducing ferric ions to ferrous ions before they approach the deposition surface (cathode).

As also mentioned above, a common approach to lower the deposition stress of CoFe and other alloys is to increase the solution temperature during deposition. However, this causes problems such as larger grain size and resultant higher coercivity of the film, and also requires specialized equipment. By using the inventive additive, the soft magnetic properties of CoFe and other alloys are kept intact, and the additive is chemically stable and active at room temperature (e.g., about 20-25° C.), which makes it easy to implement.

A preferred content of vanadium in a solution for plating CoFe is about 0.5 to about 100 millimolar (about 0.0005 to about 0.1 mol/liter), but can be higher or lower depending on the composition of the plating solution. At concentrations of about 50 millimolar and higher, traces of vanadium will be codeposited in the plated film, but do not significantly adversely affect the magnetic properties of the film.

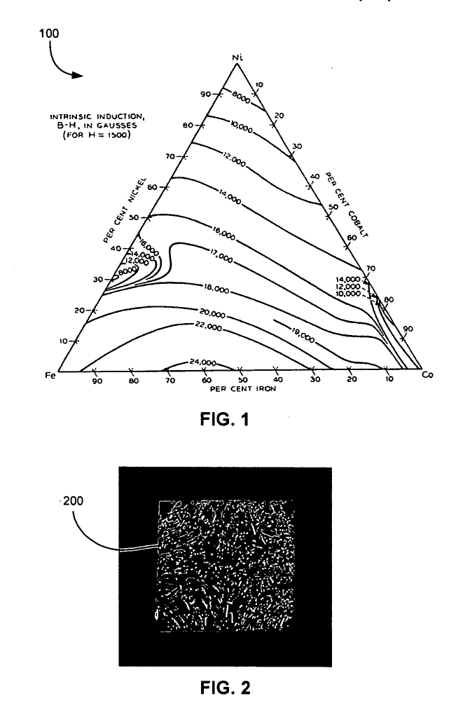

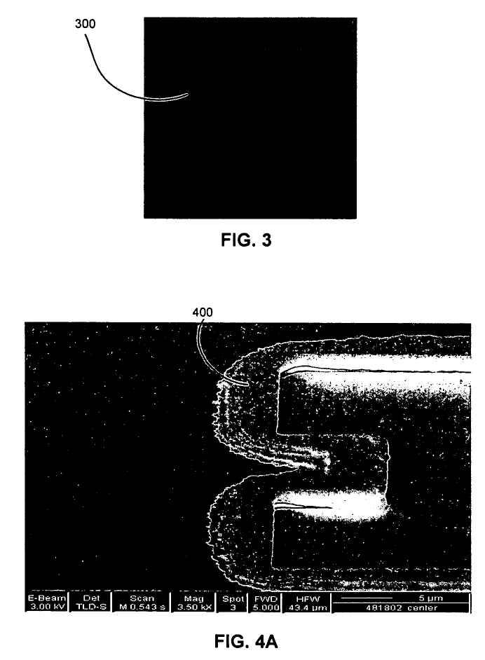

FIG. 3 shows a 10 micron-thick Co₃₆Fe₆₄ film 300 deposited in a vanadium-containing solution. As can be observed, the film is not cracked and is not peeling off of the substrate. By comparing the film shown in FIG. 3 to the film formed by standard processes and shown in FIG. 2, the improvement is self evident. Electrodeposition of CoFe alloys from a vanadium-containing bath using, salts containing V²⁺, V³⁺, and VO²⁺ ions can significantly increase the ductility of the film and therefore greatly increase the maximum thickness of CoFe films that can be electrodeposited without cracking.

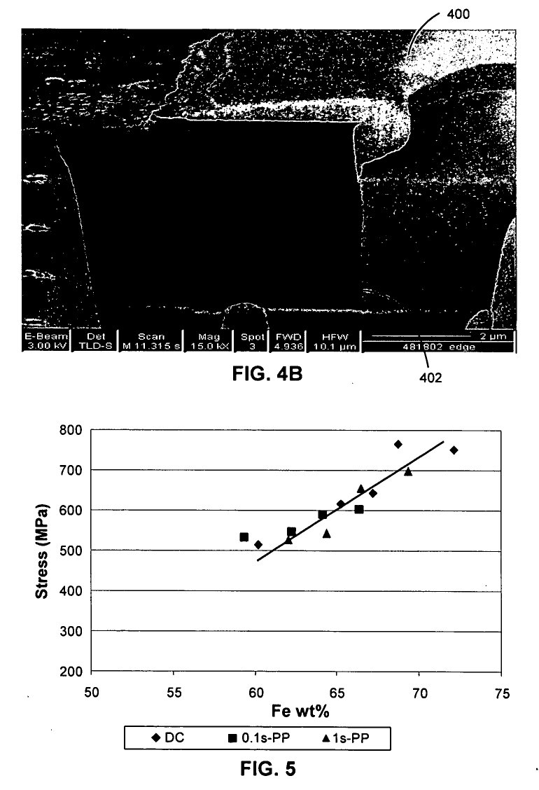

In one experiment, very thick soft magnetic CoFe films (up to 10 microns thick) with high Fe content (>50 wt%) onto sputtered Ta/Rh seedlayer on a 47 mm×47 mm glass wafer were formed without cracking or peeling off the substrate under pulse plating conditions. The growth of the high moment soft magnetic film (>2.4 T) deposited from the invented solution and under the chosen pulse plating conditions was also demonstrated to have lateral layer-by-layer growth. This is demonstrated in FIGS. 4A and 4B. As shown, the CoFe 400 grew outside the trench and grew laterally on top of the surface of the photoresist 402.

In another example, a bath was prepared to contain 18.23 g/L CoSO₄•7H₂O+x g/L FeSO₄•7H₂O+5.75 mL/L CH₃COOH+200 ppm SBS (benzenesulfinic acid, sodium salt). The x amount of FeSO₄•7H₂O was varied to make five different baths with Fe:Co ratio in the solution to be 3, 3.5, 4, 4.5, 5 respectively. From each of these baths, 3 samples were deposited. The first was DC plated at a current density (i) of 10 mA cm⁻². The second used low frequency pulsing with a pulse on current density (iₒₙ) of 10 mA cm⁻², and a pulse on-time and pulse off-time equal to 1 sec. The third used high frequency pulsing with pulse on current density (iₒₙ) of 10 mA cm⁻², and a pulse on-time and pulse off-time equal to 0.1 sec. FIG. 5 shows the stress of these three samples as a function of Fe composition in the films. As can be seen, the stress from DC (diamond-shaped), 0.1 sec pulse plating (0.1 s-PP, square-shaped), and 1 sec pulse plating (1 s-PP, triangle) follows the same trendline with similar stress at the same film composition. The stress always increases with increase of Fe composition, no matter whether the sample was deposited at DC or high frequency pulsing or low frequency pulsing.

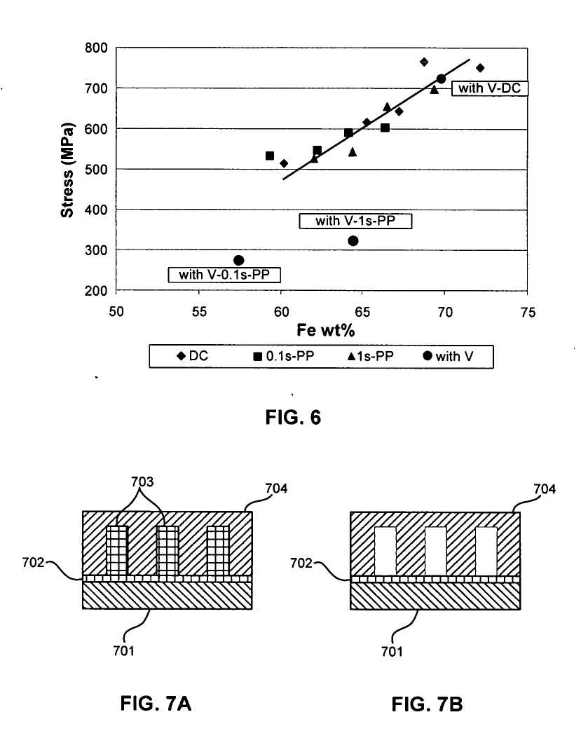

FIG. 6 shows the internal stress of CoFe films deposited from vanadium-containing solution under DC plating and under pulse plating conditions compared to the vanadium free samples shown in FIG. 5. The addition of vanadium did not lower the deposition stress in the DC plated films. However, the pulse plated samples in the vanadium solution exhibit a lower deposition stress compared to vanadium-free samples. This finding could have not been predicted and therefore is surprising, unexpected, and at the same time extremely useful and important, particularly for magnetic heads.

Referring again to FIGS. 4A and 4B, which demonstrate CoFe deposited into a patterned trench using a vanadium-containing solution along with pulse plating, it can be seen that CoFe has formed outside the trench, in a lateral direction on top of the photoresist surface. Experimentation has shown that alloys, when plated in the invented bath on a deposition surface having a conductive surface and a nonconductive mask creep laterally along the top surface of the mask. This type of metal shape evolution, when plating through a resist mask, is very surprising and has not been reported before. Nor could it have been predicted by the well known metal shape evolution model. The lateral growth mode of CoFe out of the vanadium-containing solution makes it very special and useful in forming three dimensional structures, which would have been very difficult to form using all known methods of plating.

Thus, by a strategic shaping and placement of nonconductive materials such as photoresist on a conductive plating surface in the invented bath, three dimensional plated structures of a defined shape and of various alloys can be formed. In the case of photoresist, upon formation of the plated structure, the photoresist can be removed by an appropriate solvent that selectively dissolves the resist but leaves the electrodeposited structure intact. Taking into account the various shapes that can now be produced, the newly discovered phenomenon of lateral film growth over the resist surface is of extreme importance. One can envision a great number of magnetic micro electromechanical systems (MEMS) structures, micro bridges, micro heat exchangers, overhanging beams, and growth of the film on top of sacrificial dielectrics that can now be formed.

One particularly useful structure is an electrodeposited connector that can be plated on an angled, e.g., 90° or any other angle, dielectric or at an intersection of the conductive surface and dielectric. Conversely, an electrodeposited structure can be formed to surround some or all of the dielectric for the purpose of wrapping the metal deposit around a comer of the dielectric.

The mechanism of this lateral growth on top of the photoresist, while reproducible, is not completely understood. While not wishing to be bound by any theory, the inventors believe that vanadium ions act as an inhibitor on the surface of the film during deposition, and promote growth on the steps of the edge instead. The inventors believe that this phenomenon is related to the conversion of ferric ions to ferrous ions through oxidation of low valence vanadium.

It should be apparent to one skilled in the art that the similar results will occur in any metal or alloy plating involving Co, Ni, Zn, Cu, and/or other elements and alloys in which ferric ions are present in the plating bath and to which low valence V, Mn, and/or other ions capable of existing in multiple valance states are added which are capable of reducing ferric ions to ferrous ions before they approach the deposition surface (cathode).

A method for forming three dimensional plated structures according to one embodiment includes submerging in a bath a deposition surface having a conductive portion and a nonconductive portion, the bath containing metallic ions, ferric ions, and an effective amount of an additive operative to induce formation of deposited material on the nonconductive portion. An electrical current is applied through the bath for forming an electrodeposited structure that extends laterally on the nonconductive portion. For example, FIG. 7A shows how this approach can be used to produce a micro-heat-exchanger. A silicon substrate 701 is metallized with a conductive seed layer 702, and a photoresist layer 703 is applied, exposed, and patterned with the heat exchanger structure. This structure is immersed in a CoFe plating bath containing the low valance vanadium ions, and is then electroplated until the CoFe overflows and grows rapidly over the resist 703 in the horizontal direction and merges with CoFe films growing from adjacent cavities and forms a strong upper surface of the heat exchanger 704. When plating is completed, the photoresist 703 is removed by immersing in an appropriate solvent, and an open heat exchanger structure is formed, as shown in FIG. 7B.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for electrodeposition, comprising:
creating a bath containing metallic ions, ferric ions, and an effective amount of an additive operative to reduce a tensile stress of a material formed in the bath as compared to a material formed in an otherwise identical bath not having the additive; and
pulsing an electrical current through the bath at predetermined intervals for forming an electrodeposited structure of low tensile stress.

2. The method as recited in claim 1, wherein the additive includes ions capable of reducing the ferric ions to ferrous ions.

3. The method as recited in claim 1, wherein the additive includes multi-valence ions of metals.

4. The method as recited in claim 1, wherein the additive includes vanadium ions.

5. The method as recited in claim 1, wherein the metal is selected from a group consisting of Co, Ni, Zn, and Cu.

6. The method as recited in claim 1, wherein the electrodeposited structure includes CoFe.

7. The method as recited in claim 1, wherein the electrodeposited structure has a thickness of at least about 10 microns.

8. The method as recited in claim 1, wherein the electrodeposition is conducted at room temperature.

9. The method as recited in claim 1, wherein the electrodeposited structure has a tensile stress of less than about 400 MPa.

10. A method for forming three dimensional plated structures, comprising:
submerging in a bath a deposition surface having a conductive portion and a nonconductive portion, the bath containing metallic ions, ferric ions, and an effective amount of an additive operative to induce formation of deposited material on the nonconductive portion; and
pulsing an electrical current through the bath at predetermined intervals for forming an electrodeposited structure extending laterally on the nonconductive portion.

11. The method as recited in claim 10, wherein the electrodeposited structure forms an angle along engaging surfaces of the conductive portion and the nonconductive portion.

12. The method as recited in claim 10, wherein the electrodeposited structure forms an angle along an angled surface of the nonconductive portion.

13. The method as recited in claim 10, wherein the electrodeposited structure wraps around a corner of the nonconductive portion.

14. The method as recited in claim 10, wherein the electrodeposited structure is used to form part of a micro electromechanical system (MEMS).

15. The method as recited in claim 10, wherein the electrodeposited structure is used to form a bridge.

16. The method as recited in claim 10, wherein the electrodeposited structure is used to form a heat exchanger.

17. The method as recited in claim 10, wherein the nonconductive portion is selectively removable.

18. The method as recited in claim 17, wherein the nonconductive portion is a resist.

19. The method as recited in claim 17, wherein the electrodeposited structure is used to form an overhanging beam.

20. The method as recited in claim 10, wherein the additive is operative to reduce a tensile stress of the deposited material as compared to a material formed in an otherwise identical bath not having the additive.

21. The method as recited in claim 10, wherein the method is conducted at room temperature.

22. The method as recited in claim 10, wherein the electrodeposited structure has a tensile stress of less than about 400 MPa.

23. An electrodeposited structure, comprising:
an iron alloy having a tensile stress of less than about 400 MPa.

24. The structure as recited in claim 23, wherein the iron alloy is CoFe.

25. The structure as recited in claim 23, wherein the iron alloy is NiFe.

26. The structure as recited in claim 23, wherein the iron alloy includes vanadium.

27. The structure as recited in claim 23, wherein the iron alloy is electrodeposited to a thickness of at least about 10 microns.

28. The structure as recited in claim 23, wherein the structure is part of a micro electromechanical system (MEMS).

29. The structure as recited in claim 23, wherein the structure is part of a magnetic head.

30. The structure as recited in claim 23, wherein the structure is a bridge.

31. The structure as recited in claim 23, wherein the electrodeposited structure is used to form a heat exchanger.

32. The structure as recited in claim 23, wherein the structure is an overhanging beam.

33. The structure as recited in claim 23, wherein the structure has an angled portion.

34. An electrodeposited structure, comprising:
an iron alloy having a three dimensional feature.

35. The structure as recited in claim 34, wherein the iron alloy is CoFe.

36. The structure as recited in claim 34, wherein the iron alloy is NiFe.

37. The structure as recited in claim 34, wherein the iron alloy includes vanadium.

38. The structure as recited in claim 34, wherein the structure is part of a micro electromechanical system (MEMS).

39. The structure as recited in claim 34, wherein the structure is part of a magnetic head.

40. The structure as recited in claim 34, wherein the three dimensional feature is a bridge.

41. The structure as recited in claim 34, wherein the electrodeposited structure is used to form a heat exchanger.

42. The structure as recited in claim 34, wherein the three dimensional feature is an overhanging beam.

43. The structure as recited in claim 34, wherein the three dimensional feature is an angled portion.
